(19) United States
(12) Patent Application Publication
(10) Pub. No.: US 2011/0148711 A1
(43) Pub. Date: Jun. 23, 2011

(54) POSITIONING METHOD AND COMMUNICATION SYSTEM USING THE SAME

(75) Inventors: Chi-Chung Lo, Chiayi County (TW); Che-Pin Chang, Changhua County (TW); Yueh-Feng Lee, Taipei City (TW); Chun-Hao Peng, Hsinchu City (TW); Sheng-Po Kuo, Taipei City (TW)

(73) Assignees: INDUSTRIAL TECHNOLOGY RESEARCH INSTITUTE, Hsinchu (TW); National Chiao Tung University, Hsinchu City (TW)

(21) Appl. No.: 12/844,003

(22) Filed: Jul. 27, 2010

(30) Foreign Application Priority Data
Dec. 21, 2009 (TW) 098143990

(51) Int. Cl. G01S 3/02

(52) U.S. Cl. 342/451

(57) ABSTRACT

A communication system for supporting a positioning operation within a specific area includes a system server and a communication device. The system server receives training location data corresponding to m training locations, wherein m is a natural number greater than 1, and obtains a first set and a second set of parameters according to m sets of training location data respectively corresponding to m training locations by way of conversion. The communication device downloads a part or an entire of the first set and the second set of parameters from the system server, establishes a positioning function according to the downloaded part or entire of the first set and the second set of parameters, determines to-be-positioned location data of a to-be-positioned location, and substitutes the to-be-positioned location data into the positioning function to generate positioning result data corresponding to the to-be-positioned location of communication device.

This application claims the benefit of Taiwan application Serial No. 098143990, filed Dec. 21, 2009, the subject matter of which is incorporated herein by reference.

### BACKGROUND

1. Technical Field

The disclosure relates in general to a device of a communication system, and more particularly to a communication system using a communication device therein to perform a positioning operation itself.

2. Description of the Related Art

Global positioning system (GPS) is the simplest and has provided a mature localization technique for obtaining the longitude-latitude coordinate information. The GPS performs the corresponding positioning operation according to signals outputted from satellites. In the indoor environment, the satellite signals are poorly received so that the GPS cannot operate normally. The current techniques are using wireless signals to positioning the to-be-positioned object in the indoor environment where the GPS cannot work effectively.

Conventionally, the pattern-matching positioning system is more resilient to the unpredictable signal fading effects and thus could provide higher accuracy for positioning results in more complex environments. The pattern-matching system consists of two phases: training phase and positioning phase. In the training phase, signal intensities provided by base transceiver stations on many training locations are collected to establish a training signal intensity feature vector at a system server end corresponding to each training location. The components of the training signal intensity feature vector respectively indicate the signal intensities of the base transceiver stations received at the corresponding training location.

Next, in the positioning phase, a to-be-positioned device integrates the signal intensities of the base transceiver stations collected at an unknown location as a to-be-positioned signal intensity feature vector, and provides the feature vector to the system server end. Then, the system server compares the to-be-positioned signal intensity feature vector, provided by the to-be-positioned device, with multiple training signal intensity feature vectors, which are found in the training phase and respectively correspond to multiple training locations, and thus obtains a most similar training signal intensity feature vector from the training signal intensity feature vectors, wherein its corresponding training location serves as the possible positioning location of the to-be-positioned object.

It is an important issue in the industry to design a positioning system, which is based on the wireless signals.

### SUMMARY

The disclosure is directed to a positioning method and a communication system using the same.

According to first aspect of the present disclosure, a communication system for supporting a positioning operation in a specific area is provided.

The specific area includes m training locations and n signal transceiver stations, wherein n and m are natural numbers greater than 1. The communication system includes a system server and a communication device. The system server receives a set of training location data corresponding to each of the m training locations. The set of training location data relates to signal intensities outputted from the n signal transceiver stations and detected on each of the m training locations. The system server further converts m sets of training locations data, respectively corresponding to the m training locations, into a first set of parameters and a second set of parameters, which determine a signal distribution function within the specific area. The communication device downloads a part or an entire of the first set of parameters and a part or an entire of the second set of parameters from the system server, and correspondingly establishes a positioning function, relating to the signal distribution function, on a side of the communication device. The communication device further receives signals, outputted from the n signal transceiver stations, at a to-be-positioned location to determine to-be-positioned location data, and the communication device substitutes the to-be-positioned location data into the positioning function to generate positioning result data corresponding to the to-be-positioned location of the communication device. The positioning function is a function of the to-be-positioned location data.

According to second aspect of the present disclosure, a positioning method, applied to a communication system, for supporting a positioning operation in a specific area is provided. The specific area includes m training locations and n signal transceiver stations, wherein n and m are natural numbers greater than 1. The positioning method includes the following steps. First, a set of training location data corresponding to each of the m training locations is received. The set of training location data relates to a part or an entire of signal intensities outputted from the n signal transceiver stations and detected at each of the m training locations. Next, m sets of training location data, respectively corresponding to the m training locations, are converted into a first set of parameters and a second set of parameters, which determine a signal distribution function. Then, a part or an entire of the first set of parameters and a part or an entire of the second set of parameters are downloaded from a system server to a communication device. Next, a positioning function, corresponding to the signal distribution function, is established on one side of the communication device according to a part or an entire of the downloaded first set and second set of parameters. Then, signals, outputted from the n signal transceiver stations, are received on a to-be-positioned location, where the communication device is located, to determine to-be-positioned location data. The positioning function is a function of the to-be-positioned location data. Finally, the to-be-positioned location data is substituted into the positioning function on the side of the communication device so as to generate positioning result data corresponding to the to-be-positioned location of the communication device.

The disclosure will become apparent from the following detailed description of the preferred but non-limiting embodiments. The following description is made with reference to the accompanying drawings.

### BRIEF DESCRIPTION OF THE DRAWINGS

FIG. 1 is a block diagram showing a communication system according to an embodiment of the disclosure.

FIG. 2 is a sequence diagram associated with the communication system of FIG. 1.

FIG. 3 is a block diagram showing a communication system according to a second embodiment of the disclosure.

FIG. 4 is a block diagram showing a communication system according to a third embodiment of the disclosure.

FIG. 5 is a sequence diagram associated with the communication system of FIG. 4.

### DETAILED DESCRIPTION

The disclosure relates to a communication system, wherein a system server establishes a signal distribution function according to the spatial dependence of the training space. The signal distribution function is determined by the first set of parameters and the second set of parameters. The system server transmits, through the communication link, the first set and the second set of parameters to a communication device in a communication system associated with the disclosure. Thus, the communication device can generate a positioning function corresponding to the signal distribution function according to the first set and the second set of parameters, and substitute a to-be-positioned signal intensity feature vector, received thereby, into the continuous positioning function so that the positioning operation thereof can be completed at the end of the communication device. The positioning function has the to-be-positioned signal intensity feature vector serving as a variable.

### First Embodiment

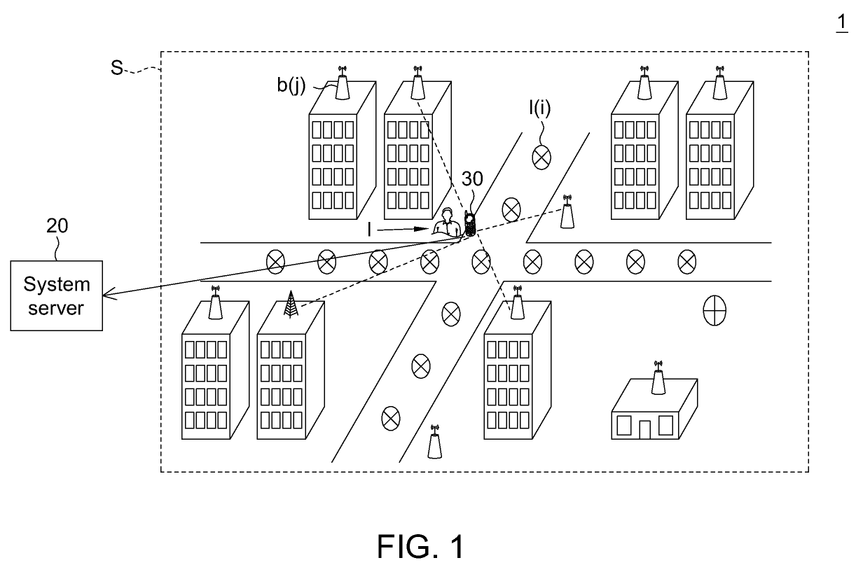

FIG. 1 is a block diagram showing a communication system 1 according to an embodiment of the disclosure. Referring to FIG. 1, the communication system 1 includes a system server 20 and a communication device 30. The communication system 1 supports a positioning operation of the communication device 30 in a specific area S. For example, the specific area S includes m training locations l1 to lm and n signal transceiver stations b1 to bn, wherein n and m are natural numbers greater than 1. For example, the signal transceiver stations b1 to bn may be a wireless local area network (Wireless LAN) signal access point (AP), a mobile phone communication system (Cellular Radio) base transceiver station (e.g., global system for mobile (GSM), a code division multiple access (CDMA), a base transceiver station for a mobile communication transmission system) or any other AP associated with the wireless communication system.

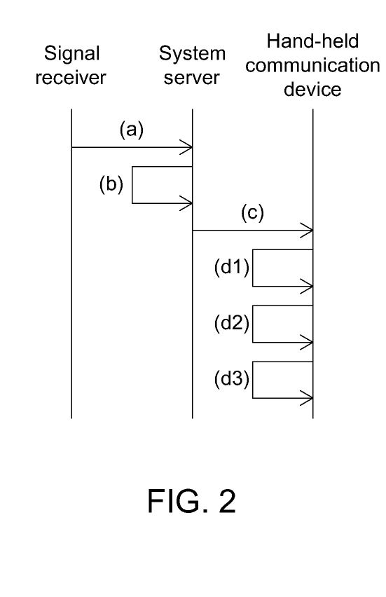

FIG. 2 shows a sequence diagram associated with the communication system of FIG. 1. In one example, the communication system 1 of this embodiment has four operation phases including a training phase, a function establishing phase, a downloading phase and a positioning phase.

The training phase is performed in the operation flow (a), in which a signal receiver is adopted to receive a wireless signal outputted from each of the n signal transceiver stations b1 to bn on each of the training locations l1 to lm, and to detect its corresponding signal intensity. The n sets of signal intensities respectively corresponding to the n signal transceiver stations b1 to bn are detected corresponding to each of the training locations l1 to lm, and the n sets of signal intensities are recorded as a corresponding set of training location data, for example. For each of the n sets of signal intensities, it may be a single signal intensity test result, a simple average or a weighted average of several signal intensities corresponding to the same signal transceiver station, or the signal intensity obtained by any other mathematical operation model. In one example, the set of training location data is a feature vector including n components. For example, the training location data corresponding to the i^{th} training location li may be labeled as the feature vector vi, which satisfies:

vi=[v(i,1), v(i,2), v(i,3), . . . , v(i,n)],

wherein v(i,1), v(i,2), . . . , and V(i,n) respectively represent the signal intensities of the wireless signals outputted from the n signal transceiver stations b1 to bn and received on the training location li, wherein “i” is a natural number smaller than or equal to m. The system server 20 receives m sets of training location data v1 to vm corresponding to all the training locations l1 to ln.

The function establishing phase is performed in the operation flow (b), in which the system server 20 converts the m sets of training location data v1 to vm respectively corresponding to the m training locations into a first set of parameters and a second set of parameters, and determines the signal distribution function according to the first and second sets of parameters. In one example, the signal distribution function is the function constructed by a long-distance signal attenuation model in a shield-free space, the model adopts the first set of parameters relating to the signal output intensity of each of the signal transceiver stations b1 to bn, and the second set of parameters relates to the environment parameters around each of the signal transceiver stations b1 to bn.

The downloading phase is performed in the operation flow (c), in which the communication device 30 downloads a part or an entire of the first set of parameters and a part or an entire of the second set of parameters from the system server 20.

The positioning phase is performed in the operation flows (d1) to (d3). First, in the operation flow (d1), the communication device 30 establishes a positioning function f corresponding to the signal distribution function on the side of the communication device 30 according to the downloaded part or entire of the first set of parameters and the downloaded part or entire of the second set of parameters.

Next, in the operation flow (d2), the communication device 30 receives the signals, outputted from the n signal transceiver stations b1 to bn, on a to-be-positioned location l so as to determine a set of to-be-positioned location data, which indicates the signal intensity corresponding to each of the n signal transceiver stations b1 to bn on the to-be-positioned location l.

Thereafter, in the operation flow (d3), the communication device 30 substitutes the to-be-positioned location data into the positioning function f to generate positioning result data corresponding to the to-be-positioned location of the communication device 30. Thus, the communication system 1 can finish the operation of positioning the communication device 30 through the four operation phases including the training phase (operation flow (a)), the function establishing phase (operation flow (b)), the downloading phase (operation flows (c)) and the positioning phase (operation flows (d1) to (d3)).

In detail, the long-distance signal attenuation model in the shield-free space adopted in the operation phase (b) may be represented by the following equation:

$$PL ( d ) = PL ( {d}_{0} ) + 10 φlog ( \frac{d }{{d}_{0}} ) ,$$

wherein d is a distance between the transmitter and the receiver; PL(d) is the signal attenuated intensity after the distance d; d₀ is a reference distance; PL(d₀) is the signal attenuated intensity under this distance; and φ is an environment variable. When the signal distribution function is established, the signal intensity Pr(l,bj), obtained on the to-be-positioned location l by the detection of the wireless signal outputted from the j^{th} signal transceiver station bj, is assumed to be equal to the emitted signal intensity Pt(j) of the signal transceiver station bj minus the signal attenuation level PL(∥ l,bj ∥) between the signal transceiver station bj and the to-be-positioned location l, wherein j is a natural number smaller than or equal to n; and ∥ l,bj ∥ is the Euclidean distance between the to-be-positioned location l and the signal transceiver station bj). When the long-distance signal attenuation model of the shield-free space is applied to the signal attenuation level PL(∥ l,bj ∥), the signal distribution function for representing the signal intensity Pr(l,bj) satisfies:

$$\begin{matrix}Pr ( l , bj ) = Pt ( j ) - PL ( ‖ l , bj ‖ ) \\ = Pt ( j ) - PL ( {d}_{0} ) - 10 \times φ ( j ) \times log ( \frac{‖ l , bj ‖}{{d}_{0}} ) \\ = {P}_{ref} ( j ) - 10 \times φ ( j ) \times log ( \frac{‖ l , bj ‖}{{d}_{0}} )\end{matrix}$$

$${P}_{ref} ( j ) = Pt ( j ) - PL ( {d}_{0} ) ,$$

wherein P_{ref}(j) is the parameter corresponding to the signal output intensity of the signal transceiver station bj; and φ(j) is the environment variable corresponding to the signal transceiver station bj.

The parameters P_{ref}(j)|j=1,2, . . . , n are the first set of parameters to be obtained in the function establishing phase, and the parameters φ(j) |j=1,2, . . . , n are the second set of parameters to be obtained in the function establishing phase. In the operations of calculating the parameters P_{ref}(j) and φ(j), the conditions that the to-be-positioned location l is equal to the i^{th} training location li (i is a natural number smaller than or equal to m) and that the signal intensity Pr(li,bj) corresponding to the i^{th} training location and the j^{th} signal transceiver station bj is equal to the j^{th} component v(i,j) of the x^{th} feature vector vi recorded in the previous training phase are substituted into the signal distribution function to obtain:

$$l = li$$

$$Pr ( li , bj ) = v ( i , j )$$

$$v ( i , j ) = {P}_{ref} ( j ) - 10 \times φ ( j ) \times log ( \frac{‖ li , bj ‖}{{d}_{0}} )$$

Because i may be any digit among 1 to m, if the signal intensities corresponding to all the m training locations are represented by a matrix, the equation may be converted into:

$$[ \begin{matrix}1 & - 10 log ( ‖ 11 , bj ‖ ) \\ 1 & - 10 log ( ‖ 12 , bj ‖ ) \\ ⋮ & ⋮ \\ 1 & - 10 log ( ‖ 1 m , bj ‖ )\end{matrix} ] \times [ \begin{matrix}{P}_{ref} ( j ) \\ φ ( j )\end{matrix} ] = [ \begin{matrix}v ( 1 , j ) \\ v ( 2 , j ) \\ ⋮ \\ v ( m , j )\end{matrix} ]$$

In one example, the best solution of the matrix containing the parameters P_{ref}(j) and φ(j) may be obtained according to the least-squares analysis to obtain the parameter P_{ref}(j) and φ(f):

$$[ \begin{matrix}{P}_{ref} ( j ) \\ φ ( j )\end{matrix} ] = {[ \begin{matrix}{P}_{ref} ( j ) & φ ( j )\end{matrix} ]}^{T} = {( {A}^{T} A )}^{- 1} {A}^{T} C$$

wherein A is the matrix

$$[ \begin{matrix}1 & - 10 log ( ‖ 11 , bj ‖ ) \\ 1 & - 10 log ( ‖ 12 , bj ‖ ) \\ ⋮ & ⋮ \\ 1 & - 10 log ( ‖ 1 m , bj ‖ )\end{matrix} ] ,$$

A^{T} is a transpose matrix of the
matrix A, and C is the matrix

$$[ \begin{matrix}v ( 1 , j ) \\ v ( 2 , j ) \\ ⋮ \\ v ( m , j )\end{matrix} ] .$$

Similar operations are applied to all the n signal transceiver stations b1 to bn to obtain the first set of parameters P_{ref}(1), P_{ref}(2), . . . , P_{ref}(n) relating to the signal intensities emitted from the n signal transceiver stations b1 to bn, and the second set of parameters φ(1) , φ(2), . . . , φ(n) relating to the environment variables of the n signal transceiver stations b1 to bn. Consequently, the operations in the function establishing phase may be finished.

In the operation flow (d2) of the positioning phase, the to-be-positioned location data s determined by the communication device 30 satisfies, for example:

s=[s₁,s₂,s₃, . . . , Sₙ],

wherein s₁, s₂, s₃, . . . , sₙ respectively represent the signal intensities of the outputted signals corresponding to the signal transceiver stations b1 to bn and received on the to-be-positioned location l.

The positioning function f relating to the signal distribution function and generated in the positioning phase satisfies, for example:

$$f ( l ) = {\sum }_{j = 1}^{n} {[ {s}_{j} - Pr ( l , bj ) ]}^{2}$$

The positioning function f(l) represents the difference between the to-be-positioned positioning data s, corresponding to the to-be-positioned location l, and the feature vector of each training location. Thus, when the positioning function f(l) has the minimum, the corresponding training location may become the optimum estimated position, which mostly approaches the to-be-positioned location l. For example, in the operation flow (d3), the communication device 30 obtains the minimum of the positioning function f(l) according to the technique composed of the gradient descent search and the tangent search.

The gradient descent search is a recursive search procedure and may be represented as:

l^{(k+1)}=l^{(k)}+αₖd^{(k)}

wherein l^{(k+1)}, l^{(k)} and d^{(k)} are two-dimensional vectors, and αₖ represents a scalar. First, a start position is randomly picked. Net, in each round of k (k≧1), we have to determine a search direction and a forward distance until we are sufficiently close to the lowest location of the target function f. Furthermore, there are two stop conditions. The first condition is to check whether the improvement magnitude between two continuous rounds of search positions is smaller than a standard value Δlₘᵢₙ. That is, the condition is:

∥l^{(k+1)}−l^{(k)}∥<Δlₘᵢₙ.

The second condition is that the number of searches has reaches a defined limit value kₘₐₓ. That is, the following equation is satisfied:

k=kₘₐₓ

After the gradient descent search is stopped, the stop position is regarded as the best solution of the target function. However, the steepest gradient descent search is adopted to determine d^{(k)} and αₖ. In each round k, the maximum ascending direction of the function is:

$$∇ f ( {l}^{( k )} ) = [ \frac{\partial f ( {l}^{( k )} )}{\partial x} , \frac{\partial f ( {l}^{( k )} )}{\partial y} ]$$

Thus, if d^{(k)}=−∇f(l^{(k)}) is selected, the function value of the target function may descend in the fastest manner. Therefore, the equation of the gradient descent search may be rewritten as:

l^{(k+1)}=l^{(k)}−αₖ∇f(l^{(k)})

Thus, the positioning function f(l) is differentiated to calculate the forward direction and the coordinate variable at a certain position, and the equations are represented as follows:

$$\begin{matrix}\begin{matrix}\frac{\partial f ( {l}^{( k )} )}{\partial x} = ( - 2 ) {\sum }_{j = 1}^{n} ( {s}_{j} - Pr ( {l}^{( k )} , bj ) ) \frac{\partial }{\partial x} Pr ( {l}^{( k )} , bj ) \\ = 20 {\sum }_{j = 1}^{n} {φ}_{j} ( {s}_{j} - Pr ( {l}^{( k )} , bj ) ) \frac{\partial }{\partial x} log ( ‖ {l}^{( k )} , bj ‖ )\end{matrix} & \\ \begin{matrix}\frac{\partial f ( {l}^{( k )} )}{\partial y} = ( - 2 ) {\sum }_{j = 1}^{n} ( {s}_{j} - Pr ( {l}^{( k )} , bj ) ) \frac{\partial }{\partial y} Pr ( {l}^{( k )} , bj ) \\ = 20 {\sum }_{j = 1}^{n} {φ}_{j} ( {s}_{j} - Pr ( {l}^{( k )} , bj ) ) \frac{\partial }{\partial y} log ( ‖ {l}^{( k )} , bj ‖ )\end{matrix} & \end{matrix}$$

Assume the gradient at the certain position is ∇f(l), the equations may be calculated as:

$$\begin{matrix}f ( {l}^{( k )} - β ∇ f ( {l}^{( k )} ) ) = {\sum }_{j = 1}^{n} {( {s}_{j} - Pr ( {l}^{( k )} - β ∇ f ( {l}^{( k )} ) , bj ) )}^{2} \\ = {\sum }_{j = 1}^{n} ( {s}_{j} - {P}_{ref}^{j} + 10 {φ}_{j} log ( {‖ {l}^{( k )} - β ∇ f ( {l}^{( k )} , bj ‖ )}^{2} \\ = {\sum }_{j = 1}^{n} {Θ}_{j}^{2}\end{matrix}$$

Next, the most convergence value is obtained using the tangent search, which may be represented as follows:

$${β}_{t + 1} = {β}_{t} - \frac{{β}_{t} - {β}_{t - 1}}{{G}_{k}^{′} ( {β}_{t} ) - {G}_{k}^{′} ( {β}_{t} - 1 )} - {G}_{k}^{′} ( {β}_{t} )$$

$$wherein {G}_{k} ( β ) = f ( {l}^{( k )} - β ∇ f ( {l}^{( k )} ) )$$

In addition, the sum of any two initial values β₀ and β₁ is taken, and introduced into:

$$\begin{matrix}{G}_{k}^{′} ( β ) = \frac{\partial }{\partial β} f ( {l}^{( k )} - β ∇ f ( {l}^{( k )} ) ) \\ = 20 {\sum }_{j = 1}^{n} {φ}_{j} {Θ}_{j} \frac{\partial }{\partial β} log ( ‖ {l}^{( k )} - β ∇ f ( {l}^{( k )} , bj ‖ )\end{matrix}$$

When the calculated β satisfies |βₜ₊₁−βₜ|<Δβₘᵢₙ or t=tₘₐₓ, the tangent search is stopped, wherein Δβₘᵢₙ and tₘₐₓ are predetermined parameters.

Thereafter, the communication device 30 substitutes the most convergence value of β into the αₖ in the equation of the gradient descent search, and judges whether the positioning function f(l) is converged to the minimum to judge whether the certain position l^{(k)} is the most convergence value. If the certain position l^{(k)} is not the most convergence value, the operations of the above-mentioned equations are repeated based on the certain position l^{(k)} to again obtain ∇f(l^{(k+1)}) and αₖ₊₁, which are then substituted into the equation of the gradient descent search and the above-mentioned equations are repeated until the most convergence value of the to-be-positioned position l is obtained. Heretofore, the communication device 30 finishes the operation of the operation flow (d3) to finish the position of the position thereof.

In the communication system 1 of the embodiment, the minimum of the positioning function f(l) is searched using the steepest gradient descent search and the tangent search in the positioning phase. However, the communication system of this embodiment is not limited thereto, and other existing optimum algorithms (e.g., regression analysis) may be adopted to search the minimum of the positioning function f(l).

### Second Embodiment

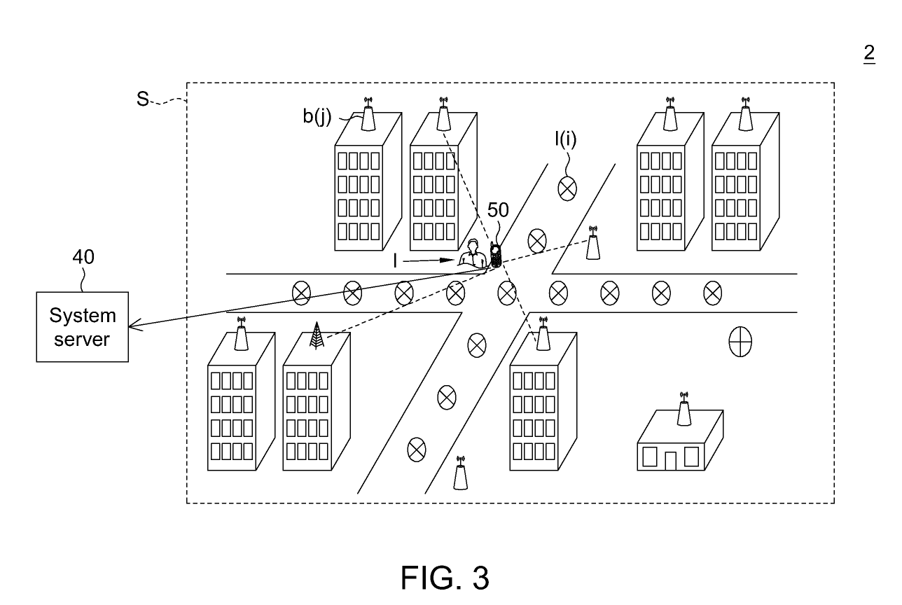

FIG. 3 is a block diagram showing a communication system according to a second embodiment of the disclosure. As shown in FIG. 3, the difference between the communication system of the second embodiment and the communication system of the first embodiment is that the communication system of the second embodiment a distance inverse interpolation method is adopted to establish the signal distribution function in the function establishing phase. In the function establishing phase, for example, a system server 40 may also establish the signal distribution function according to the distance inverse interpolation method. After the feature vectors v1 to vm corresponding to each of the m training locations l1 to lm are generated, the system server 40 calculates the signal intensity Pr(l,bj) corresponding to the signal transceiver station bj on the to-be-positioned location l in a weighted manner according to the inverse interpolation model with reference to the signal intensities v(1,j), v(2,j), . . . , v(m,j) corresponding to the signal transceiver station bj on all the training locations l1 to lm. For example, the intensity distribution function corresponding to the inverse interpolation model satisfies:

$$Pr ( l , bj ) = \frac{1}{{\sum }_{li ∈ S}^{ } ω i} {\sum }_{li ∈ S}^{ } ω i \times v ( i , j )$$

wherein the signal intensity Pr(l,bj) represents the signal intensity corresponding to the signal transceiver station bj on the to-be-positioned location l; v(i,j) represents the signal intensity corresponding to the j^{th} signal transceiver station bj on the training location li; and ωi satisfies

ωi=∥l,li∥^{-λ}

l and li are respectively the training locations of the to-be-positioned location, λ is the system parameter having the value greater than 0. The weighting coefficients of the signal intensities v(1,j) to v(m,j) of each reference are determined according to ωi, and the term:

$$\frac{1}{{\sum }_{li ∈ S}^{ } ω i}$$

is used to form a normalization reference term to perform the normalization operation on the signal intensity generated by weighting the signal intensities v(1,j) to v(mj).

However, the signal intensity gradient ∇Pr(li, bj) detected on each of the training locations l1 to lm is equal to zero according to the intensity distribution function established by the inverse interpolation model. Thus, the steepest gradient descent search operation relating to the signal intensity gradient in the positioning phase has the problem. In order to solve this problem, the system server 40 sets the signal intensity corresponding to the signal transceiver station bj on each of the training locations l1 to lm to have an artificial gradient value in the function establishing phase. The artificial gradient value satisfies:

∇Pr(li, bj)=[g_{i,j,}^{x}g_{i,j}^{y}]^{T}

In one example, the system server 40 establishes a continuous tangent plane of the signal intensity on each feature vector v(i,j). For example, the continuous tangent may be expressed as follows:

T_{i,j}⁽l)=v(i, j)+g_{i,j}^{x}×(x−xi)+g_{i,j}^{y}×(y−yi)

wherein (x,y) is the position of the to-be-positioned location l; and (xi,yi) is the position of the training location li.

The relationship corresponding to each of the training locations satisfying the condition le=(xe, ye)∈ Ng(l) may be established as follows:

g_{i,j}^{x}(xe−xi)+g_{i,j}^{y}(ye−yi)=v(e,j)−v(i,j)

According to the Ng(l) group (Ng(l) is the training position group that may affect the constructed T_{i,j}(l) plane) having ∈ training locations around the training location, the relationships between all the coordinates and the feature vectors may be represented as:

$$[ \begin{matrix}x 1 - x i & y 1 - y i \\ x 2 - x i & y 2 - y i \\ ⋮ & ⋮ \\ x e - x i & y e - y i\end{matrix} ] \times [ \begin{matrix}{g}_{i , j}^{x} \\ {g}_{i , j}^{y}\end{matrix} ] = [ \begin{matrix}v ( 1 , j ) - v ( i , j ) \\ v ( 2 , j ) - v ( i , j ) \\ ⋮ \\ v ( e , j ) - v ( i , j )\end{matrix} ]$$

In one example, the best solution of the matrix including the parameters g_{i,j}^{x} and g_{i,j}^{y} are searched according to the least-squares analysis so that the parameters g_{i,j}^{x} and g_{i,j}^{y} may be obtained:

$$[ \begin{matrix}{g}_{i , j}^{y} \\ {g}_{i , j}^{x}\end{matrix} ] = {[ \begin{matrix}{g}_{i , j}^{x} & {g}_{i , j}^{y}\end{matrix} ]}^{T} = {( {A}^{T} A )}^{- 1} {A}^{T} C$$

wherein A is the matrix

$$[ \begin{matrix}x 1 - x i & y 1 - y i ) \\ x 2 - x i & y 2 - y i ) \\ ⋮ & ⋮ \\ x e - x i & y e - y i )\end{matrix} ] ,$$

A^{T} is the transpose matrix of the matrix A, and C is the matrix

$$[ \begin{matrix}v ( 1 , j ) - v ( i , j ) \\ v ( 2 , j ) - v ( i , j ) \\ ⋮ \\ v ( e , j ) - v ( i , j )\end{matrix} ] .$$

Thereafter, the system server 40 regards G_{i,j}^{x} and G_{i,j}^{y} as the gradient information of the signal intensity on the training position li, and modifies the intensity distribution function corresponding to the inverse interpolation model into:

$$Pr ( l , bj ) = \frac{1}{{\sum }_{li ∈ S}^{ } ω i} {\sum }_{li ∈ S}^{ } ω i \times {T}_{i , j} ( l )$$

The similar operations are applied to all the n signal transceiver stations b1 to bn to obtain the associated first set of parameters (i=1 to m; j=1 to n) and the associated second set of parameters (i=1 to m; j=1 to n) and thus finish the operations in the function establishing phase.

In another embodiment, the intensity distribution function established according to the inverse interpolation model may also be established selectively according to the signal intensities detected at the training locations near the to-be-positioned location l, rather than the signal intensities detected on all the training locations so that the operation load may be lowered. For example, we only consider the signal intensities detected on the τ position reference locations in the sub-area Nr(l) of the specific area S, wherein the physical position of the sub-area Nr(1) approaches the to-be-positioned location l, and the intensity distribution function established according to the inverse interpolation model may be rewritten as:

$$Pr ( l , bj ) = \frac{1}{{\sum }_{li ∈ Nr ( l )}^{ } ω i} {\sum }_{li ∈ Nr ( l )}^{ } ω i \times {T}_{i , j} ( l )$$

The main feature using the interpolation method resides in that the coefficient of the signal intensity function is not constant, but may be dynamically changed according to different positions. Thus, in the processes of collecting and constructing the training data, the constant signal intensity function cannot be generated while the signal intensity function is dynamically generated during the positioning process.

The system server 40 constructs the coordinate of each training location and its corresponding feature vector and gradient information into a data structure with the spatial dependence. In general, when the data is being stored, the used data structure is the R tree structure in order to speed up the subsequent positioning operation.

In the positioning phase, a communication device 50 utilizes the gradient descent search to converge the differential function f to a minimum. The differential function f is differentiated to calculate the forward direction and the coordinate variable at a certain position, wherein the gradient is represented as follows:

$$\begin{matrix}\begin{matrix}\frac{\partial f ( {l}^{( k )} )}{\partial x} = ( - 2 ) {\sum }_{j = 1}^{n} ( {s}_{j} - Pr ( {l}^{( k )} , bj ) ) \frac{\partial }{\partial x} Pr ( {l}^{( k )} , bj ) \\ = ( - 2 ) {\sum }_{j = 1}^{n} ( {s}_{j} - Pr ( {l}^{( k )} , bj ) ) \frac{{D}_{j , 1}^{X} {D}_{j , 2}^{X} - {D}_{j , 3}^{X} {D}_{j , 4}^{X}}{{D}_{j , 1}^{X} {D}_{j , 1}^{X}}\end{matrix} & \\ \begin{matrix}\frac{\partial f ( {l}^{( k )} )}{\partial y} = ( - 2 ) {\sum }_{j = 1}^{n} ( {s}_{j} - Pr ( {l}^{( k )} , bj ) ) \frac{\partial }{\partial y} Pr ( {l}^{( k )} , bj ) \\ = ( - 2 ) {\sum }_{j = 1}^{n} ( {s}_{j} - Pr ( {l}^{( k )} , bj ) ) \frac{{D}_{j , 1}^{Y} {D}_{j , 2}^{Y} - {D}_{j , 3}^{Y} {D}_{j , 4}^{Y}}{{D}_{j , 1}^{Y} {D}_{j , 1}^{Y}}\end{matrix} & \end{matrix}$$

wherein:

$${D}_{j , 1}^{X} = {D}_{j , 1}^{Y} = {\sum }_{li ∈ Nr ( {l}^{( k )} )}^{ } ω i$$

$${D}_{j , 2}^{X} = {\sum }_{li ∈ Nr ( {l}^{( k )} )}^{ } ( ω i \times {g}_{i , j}^{x} + {T}_{i , j} ( {l}^{( k )} ) \frac{\partial }{\partial x} ω i )$$

$${D}_{j , 2}^{Y} = {\sum }_{li ∈ Nr ( {l}^{( k )} )}^{ } ( ω i \times {g}_{i , j}^{y} + {T}_{i , j} ( {l}^{( k )} ) \frac{\partial }{\partial y} ω i )$$

$${D}_{j , 3}^{X} = {D}_{j , 3}^{Y} = {\sum }_{li ∈ Nr ( {l}^{( k )} )}^{ } {T}_{i , j} ( {l}^{( k )} ) ω i$$

$${D}_{j , 4}^{X} = {\sum }_{li ∈ Nr ( {l}^{( k )} )}^{ } \frac{\partial }{\partial x} ω i$$

$${D}_{j , 4}^{Y} = {\sum }_{li ∈ Nr ( {l}^{( k )} )}^{ } \frac{\partial }{\partial y} ω i$$

In order to calculate the forward distance of the gradient descent search, the communication device 50 establishes the following functions:

$$\begin{matrix}f ( {l}^{( k )} - β ∇ f ( {l}^{( k )} ) ) = {\sum }_{j = 1}^{n} {[ {s}_{j} - Pr ( {l}^{( k )} - β ∇ f ( {l}^{( k )} ) , bj ) ]}^{2} \\ = {\sum }_{j = 1}^{n} {( {s}_{j} - \frac{1}{{\sum }_{li ∈ Nr ( {l}^{( k )} )}^{ } ω i} {\sum }_{li ∈ Nr ( {l}^{( k )} )}^{ } ω i \times {T}_{i , j} ( {l}^{( k )} ) )}^{2} \\ = {\sum }_{j = 1}^{n} {Θ}_{j}^{2}\end{matrix}$$

wherein:

$${l}^{( k + 1 )} = {l}^{( k )} - {α}_{k} ∇ f ( {l}^{( k )} )$$

$$ω i = \frac{1}{{‖ {l}^{( k )} - β ∇ f ( {l}^{( k )} ) , li ‖}^{λ}}$$

For the sake of simplicity, the communication device 50 lets l^{(k+1)}=l^{(k)}−αₖ∇f(l^{(k)}), and obtains the most convergence value of β according to the tangent search and the equation:

$${β}_{t + 1} = {β}_{t} - \frac{{β}_{t} - {β}_{t - 1}}{{G}_{k}^{′} ( {β}_{t} ) - {G}_{k}^{′} ( {β}_{t} - 1 )} {G}_{k}^{′} ( {β}_{t} ) ,$$

wherein the calculating equation of G′ₖ(β) is, for example:

$${G}_{k}^{′} ( β ) = 2 {\sum }_{j = 1}^{n} {Θ}_{j} \frac{{E}_{j , 2} {E}_{j , 3} + {E}_{j , 1} ( {E}_{j , 4} - {E}_{j , 5} )}{{E}_{j , 1} {E}_{j , 1}}$$

wherein:

$${E}_{j , 1} = {\sum }_{li ∈ Nr ( {l}^{( k )} )}^{ } ω i$$

$${E}_{j , 2} = {\sum }_{li ∈ Nr ( {l}^{( k )} )}^{ } ω i \times {T}_{i , j} ( {l}^{( k )} )$$

$${E}_{j , 3} = {\sum }_{li ∈ Nr ( {l}^{( k )} )}^{ } \frac{\partial }{\partial β} ω i$$

$${E}_{j , 4} = {\sum }_{li ∈ Nr ( {l}^{( k )} )}^{ } ω i ( {g}_{i , j}^{x} \frac{\partial }{\partial x} f ( {l}^{( k )} ) + {g}_{i , j}^{y} \frac{\partial }{\partial y} f ( {l}^{( k )} ) )$$

$${E}_{j , 5} = {\sum }_{li ∈ Nr ( {l}^{( k )} )}^{ } {T}_{i , j} ( {l}^{( k )} ) \frac{\partial }{\partial β} ω i$$

Thereafter, the communication device 50 substitutes the most convergence value of β into the αₖ in the equation:

l^{(k+1)}=l^{(k)}+αₖd^{(k)}

in order to judge whether the positioning function f is converged to the minimum to judge whether the certain position l^{(k)} is the most convergence value. If the certain position l^{(k)} is not the most convergence value, the training position group is updated based on the certain position l^{(k)} and the R tree data structure. Thus, the dynamic signal intensity function and the dynamic differential function of each base transceiver station are changed, and then the following equations are repeated:

$$\begin{matrix}{β}_{t + 1} = {β}_{t} - \frac{{β}_{t} - {β}_{t - 1}}{{G}_{k}^{′} ( {β}_{t} ) - {G}_{k}^{′} ( {β}_{t} - 1 )} {G}_{k}^{′} ( {β}_{t} ) & \\ \begin{matrix}\frac{\partial f ( {l}^{( k )} )}{\partial x} = ( - 2 ) {\sum }_{j = 1}^{n} ( {s}_{j} - Pr ( {l}^{( k )} , bj ) ) \frac{\partial }{\partial x} Pr ( {l}^{( k )} , bj ) \\ = ( - 2 ) {\sum }_{j = 1}^{n} ( {s}_{j} - Pr ( {l}^{( k )} , bj ) ) \frac{{D}_{j , 1}^{X} {D}_{j , 2}^{X} - {D}_{j , 3}^{X} {D}_{j , 4}^{X}}{{D}_{j , 1}^{X} {D}_{j , 1}^{X}}\end{matrix} & \\ \begin{matrix}\frac{\partial f ( {l}^{( k )} )}{\partial y} = ( - 2 ) {\sum }_{j = 1}^{n} ( {s}_{j} - Pr ( {l}^{( k )} , bj ) ) \frac{\partial }{\partial y} Pr ( {l}^{( k )} , bj ) \\ = ( - 2 ) {\sum }_{j = 1}^{n} ( {s}_{j} - Pr ( {l}^{( k )} , bj ) ) \frac{{D}_{j , 1}^{Y} {D}_{j , 2}^{Y} - {D}_{j , 3}^{Y} {D}_{j , 4}^{Y}}{{D}_{j , 1}^{Y} {D}_{j , 1}^{Y}}\end{matrix} & \\ \begin{matrix}f ( {l}^{( k )} - β ∇ f ( {l}^{( k )} ) ) = {\sum }_{j = 1}^{n} {( {s}_{j} - Pr ( {l}^{( k )} - β ∇ f ( {l}^{( k )} ) , bj ) )}^{2} \\ = {\sum }_{j = 1}^{n} ( {s}_{j} - {P}_{ref}^{j} + 10 {φ}_{j} {log ( ‖ \begin{matrix}{l}^{( k )} - \\ β ∇ f ( {l}^{( k )} , bj\end{matrix} ‖ )}^{2} \\ = {\sum }_{j = 1}^{n} {Θ}_{j}^{2}\end{matrix} & \\ {G}_{k}^{′} ( β ) = 2 {\sum }_{j = 1}^{n} {Θ}_{j} \frac{{E}_{j , 2} {E}_{j , 3} + {E}_{j , 1} ( {E}_{j , 4} - {E}_{j , 5} )}{{E}_{j , 1} {E}_{j , 1}} & \end{matrix}$$

so that the most convergence value of β is again obtained and then substituted back into the equation:

l^{(k+1)}=l^{(k)}+αₖd^{(k)}

The above-mentioned operations are repeated until the most convergence value of the to-be-positioned position l is obtained. Thus, the communication device 50 can finish the positioning operation on the position where it is located.

### Third Embodiment

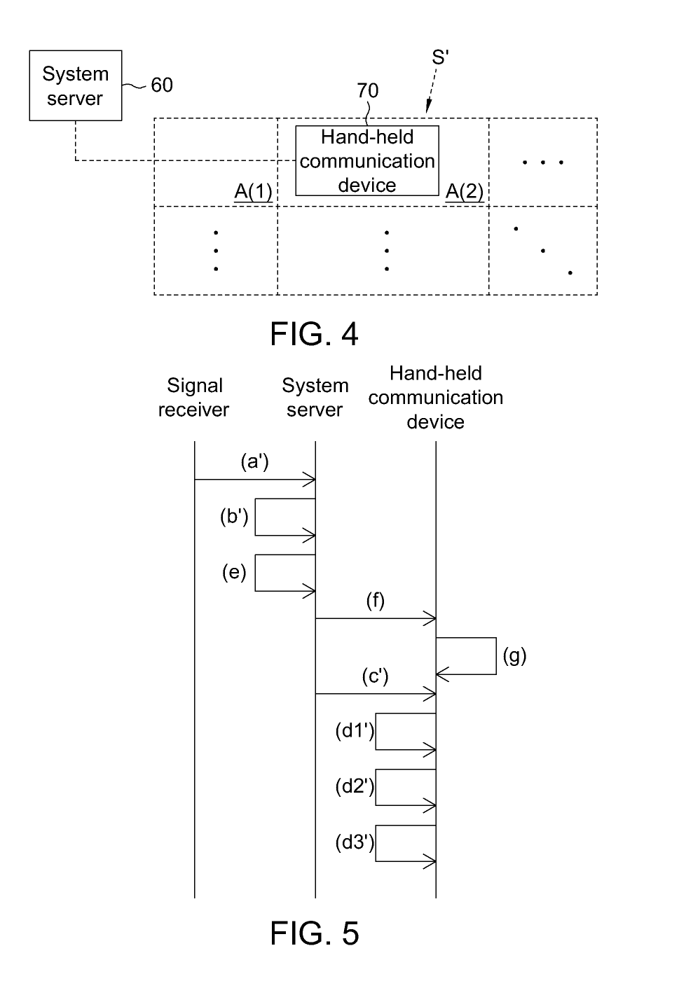

The communication system of this embodiment further applies a memory management algorithm to selectively adjust the data quantities of the first set of parameters and the second set of parameters downloaded by the communication device. FIG. 4 is a block diagram showing a communication system according to a third embodiment of the disclosure. FIG. 5 shows a sequence diagram associated with the communication system of FIG. 4. As shown in FIGS. 4 and 5, the difference between the communication system of the third embodiment and that of the first or second embodiment is that the system server 60 of this embodiment further partitions the specific area S′ into K partitions A(1), A(2) . . . , A(K), and correspondingly divides the first set of parameters, obtained in the function establishing phase, into K groups and divides the second set of parameters into K groups, wherein the K groups of the first set of parameters respectively correspond to the K partitions, and the K groups of the second set of parameters also respectively correspond to the K partitions. The system server 60 further establishes a clustering look-up table to correspond the K groups of the first set of parameters to the K partitions, respectively, and to correspond the K groups of the second set of parameters to the K partitions, respectively. For example, the operations of partitioning the specific area S′ and establishing the clustering look-up table are performed in the flow (e) between the function establishing phase (b′) and the downloading phase (c′).

Similar to the specific area S shown in FIGS. 1 and 3 of the first and second embodiments, the specific area S′ of this embodiment also includes n signal transceiver stations and m training locations distributed in each of the K partitions A(1) to A(K). In this embodiment, however, each training location and each signal transceiver station are not depicted in FIG. 4 in order to clearly depict each of the partitions A(1) to A(K) and the specific area S′.

An operation flow (f) after the flow (e) may further be included, in which the communication device 70 downloads the clustering look-up table from the system server 60, and judges the to-be-positioned location of the communication device 70 as approaching at least one current position partition of the K partitions A(1) to A(K) according to the start position data corresponding to the to-be-positioned location of the communication device 70. For example, the communication device 70 adopts the positioning result data, obtained in its previous positioning operation, as the start position data. In another example, the communication device 70 includes another positioning module (not shown), and the communication device 70 determines the start position data according to another set of positioning result data provided by the another positioning module, wherein the another positioning module is, for example, a global positioning system (GPS) positioning module. In still another example, the start position data is provided by the system server 60. For example, the system server 60 utilizes the conventional wireless signal positioning system performs a pre-positioning operation on the communication device 70 before the operation of the downloading phase so as to obtain the start position data. For example, the system server 60 provides the start position data to the communication device 70 in the downloading phase. In addition, the clustering look-up table could store in the memory of the communication device.

The flow (g) after the flow (f) may further be included, in which the communication device 70 finds the corresponding current position partition according to the start position data indicating its current position. Then, the flow (c′) is performed to download, from the system server 60, the portions corresponding to the current position partition in the K groups of the first set of parameters and the K groups of the second set of parameters. Thereafter, the flows (d1′) to (d3′) are performed to establish the positioning function and generate the positioning result data according to the downloaded portions of the first set of parameters and the second set of parameters. For example, the communication device 70 falls within the partition A(2), and the current position partition is the partition A(2). Thus, the communication device 70 of this embodiment can finish the positioning operation of the to-be-positioned location on the communication device 70 itself under the condition where the portions of the first set of parameters and the second set of parameters are received, but not the entire of the first and second sets of parameters are downloaded. Consequently, the memory capacity that has to be prepared corresponding to the positioning operation in the communication device 70 may be effectively reduced so that the communication device 70 has the better memory usage efficiency.

In one embodiment, the communication device 70 may further obtain the relationship between the physical positions of the to-be-positioned location of the communication device 70 and the current position partition according to the positioning result data obtained by its positioning, and thus determine whether to download other portions of the K groups of first sets of parameters and the K groups of the second set of parameters or not to perform the positioning operation on the communication device 70.

When the generated positioning result data indicates that the position of the communication device 70 approaches the boundary of the current position partition, the communication device 70 decides to download the other portions of the K groups of the first set of parameters and the K groups of the second set of parameters to update the first and second sets of parameters on the side of the communication device 70, and to perform the positioning operation on the communication device 70 approaching the boundary of the current position partition.

In the operations of downloading the other portions of the K groups of the first set of parameters and the K groups of the second set of parameters, for example, the communication device 70 judges the moving direction of the communication device 70 according to x sets of positioning result data obtained in the previous x positioning operations, and thus determines the moving direction data, wherein x is a natural number greater than 1. The communication device 70 also finds the next position partition according to the moving direction data, and correspondingly downloads the portions corresponding to the next position partition from the K groups of the first set of parameters and the K groups of the second set of parameters so as to update the parameter data on the side of the communication device 70. For example, if the moving direction of the communication device 70 is directed to the direction (the right side of FIG. 4) from the partition A(1) to the partition A(2), then the next position partition is the partition A(1), for example.

In another example, the communication device 70 selects y peripheral position partitions around the current position partition (e.g., the partition A(2)) as the next set of possible position partitions, and correspondingly downloads the portions corresponding to the next set of possible position partitions from the K groups of the first set of parameters and the K groups of the second set of parameters so as to update the parameter data on the side of the communication device 70, wherein y is a natural number and has a value relating to the memory capacity of the communication device 70. For example, if the communication device 70 can allow the data quantity corresponding to two groups of the first set of parameters and two groups of the second set of parameters of two partitions, then y is equal to 2, and the y peripheral position partitions are, for example, the partitions surrounding the current position partition, such as the partitions A(1) and A(3).

In still another example, the communication device 70 selects N (N=8 in the following example) peripheral position partitions around the current position partition as the next set of possible position partitions, and correspondingly downloading, from the K groups of the first set of parameters and the K groups of the second set of parameters, the portions corresponding to the eight peripheral position partitions.

In the illustrated embodiment, the communication device 70 finds a corresponding current position partition (i.e., the partition A(2)) according to the start position data. However, the communication device 70 is not limited thereto. In other examples, the communication device 70 may also find the corresponding current position partitions, which approach the current position of the communication device 70, according to the start position data. For example, the communication device 70 adopts the partitions A(1), A(2) and (3) substantially approaching its current position as the current position partitions, and correspondingly performs the positioning operation according to three groups of the first set of parameters and three groups of the second set of parameters corresponding the partitions A(1) to A(3).

The system server in the communication system according to the embodiment of the disclosure establishes the signal distribution function according to the spatial dependence of the training space. The signal distribution function is determined according to the first set of parameters and the second set of parameters. The system server further transmits the first and second sets of parameters to the communication device through the communication link in the communication system. Thus, the communication device can generate a positioning function corresponding to the signal distribution function according to the first and second sets of parameters, and substitutes the to-be-positioned signal intensity feature vector received thereby into the continuous function so as to finish the positioning operation thereof at the end of the communication device. The to-be-positioned signal intensity feature vector serves as the variable in the positioning function. Thus, compared with the conventional wireless signal positioning system, the communication system according to the embodiment of the disclosure has the following advantages. First, the data quantity to be stored in the positioning operation may be reduced by converting the huge amount of training location data into the positioning function determined by the first set of parameters and the second set of parameters. Second, the data operation loading needed in the positioning operation can be effectively lowered. Third, the overall positioning operations can be completed by the communication device. Fourth, the transmission bandwidth of the communication link between the communication device and the system server needs not to be occupied in the positioning operation.

The communication device could be a hand-held communication device.

While the disclosure has been described by way of examples and in terms of preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A communication system for supporting a positioning operation in a specific area, which comprises m training locations and n signal transceiver stations, wherein n and m are natural numbers greater than 1, the communication system comprising:
a system server for receiving a set of training location data corresponding to each of the m training locations, wherein the set of training location data relates to signal intensities outputted from the n signal transceiver stations and detected on each of the m training locations, the system server further converts m sets of training location data, respectively corresponding to the m training locations, into a first set of parameters and a second set of parameters, which determine a signal distribution function within the specific area; and
a communication device for downloading a part or the entirety of the first set of parameters and a part or the entirety of the second set of parameters from the system server, and correspondingly establishing a positioning function, relating to the signal distribution function, on a side of the communication device, wherein the communication device further receives signals, outputted from the n signal transceiver stations, at a to-be-positioned location to determine to-be-positioned location data, and the communication device substitutes the to-be-positioned location data into the positioning function to generate positioning result data corresponding to the to-be-positioned location of the communication device;
wherein the positioning function is a function of the to-be-positioned location data;
wherein the system server has means to further perform area partitioning according to actual spatial positions of the m training locations to partition the m training locations into K partitions, the system server further establishes a clustering look-up table for dividing the first set of parameters into K groups respectively corresponding to the K partitions, and also dividing the second set of parameters into K groups respectively corresponding to the K partitions, wherein each of the K partitions comprises at least one of the m training locations, and K is a natural number greater than 1; and
wherein the communication device further downloads the clustering look-up table from the system server and finds the to-be-positioned location of the communication device approaching at least one current position partition of the K partitions according to start position data corresponding to the to-be-positioned location of the communication device, wherein the communication device downloads a portion the K groups of the first set and the second set of parameters corresponding to the at least one current position partition, and therefrom establishes the positioning function and generates the positioning result data.

2. The system according to claim 1, wherein the first set of parameters comprises n sets of intensity data respectively corresponding to emitted signal intensities of the n signal transceiver stations, and the second set of parameters comprises n sets of environment variable data respectively corresponding to signal attenuation models of environments where the n signal transceiver stations are located.

3. (canceled)

4. (canceled)

5. The system according to claim 1, wherein the communication device further calculates a relationship between a position of the communication device and a physical position of the at least one current position partition according to the obtained positioning result data, and therefrom determines whether to download the other portion of the K groups of the first set and the second set of parameters or not, so as to perform the positioning operation on the communication device.

6. The system according to claim 5, wherein the communication device determines to download the other portion of the K groups of the first set and the second set of parameters when the positioning result data indicates that the position of the communication device approaches a boundary of the at least one current position partition.

7. The system according to claim 6, wherein the communication device has means to find moving direction data of the communication device according to x sets of the positioning result data obtained in previous x positioning operations, and therefrom find a next position partition, and correspondingly download the other portion of the K groups of the first set and the second set of parameters, which corresponds to the next position partition, wherein x is a natural number greater than 1.

8. The system according to claim 6, wherein the communication device selects y peripheral position partitions around the at least one current position partition as a next set of possible position partitions, and correspondingly downloads the other portion of the K groups of the first set and the second set of parameters, which corresponds to the next set of possible position partitions, wherein y is a natural number.

9. The system according to claim 6, wherein the communication device has means to select N peripheral position partitions around the at least one current position partition as a next set of possible position partitions, and correspondingly download the other portion of the K groups of the first set and the second set of parameters, which corresponds to the next set of possible position partitions, wherein N is a natural number.

10. The system according to claim 1, wherein the communication device determines the start position data according to positioning result data obtained in a previous positioning operation.

11. The system according to claim 1, wherein the communication device further comprises another positioning module for generating another set of positioning result data, and the communication device determines the start position data according to the another set of positioning result data.

12. The system according to claim 1, wherein the start position data is provided by the system server.

13. A positioning method, applied to a communication system, for supporting a positioning operation in a specific area, which comprises m training locations and n signal transceiver stations, wherein n and m are natural numbers greater than 1, the positioning method comprising the steps of:
receiving a set of training location data corresponding to each of the m training locations, wherein the set of training location data relates to a part or the entirety of signal intensities outputted from the n signal transceiver stations and detected at each of the m training locations;
converting m sets of training location data, respectively corresponding to the m training locations, into a first set of parameters and a second set of parameters, which determine a signal distribution function;
downloading a part or the entirety of the first set of parameters and downloading a part or the entirety of the second set of parameters from a system server to a communication device;
establishing a positioning function, corresponding to the signal distribution function, on one side of the communication device according to a part or the entirety of the downloaded first set and second set of parameters;
receiving signals, outputted from the n signal transceiver stations, on a to-be-positioned location, where the communication device is located, to determine to-be-positioned location data, wherein the positioning function is a function of the to-be-positioned location data;
substituting the to-be-positioned location data into the positioning function on the side of the communication device so as to generate positioning result data corresponding to the to-be-positioned location of the communication device;
performing area partitioning according to actual spatial positions of the m training locations to partition the m training locations into K partitions;
establishing a clustering look-up table to divide the first set of parameters into K groups respectively corresponding to the K partitions, and to divide the second set of parameters into K groups respectively corresponding to the K partitions, wherein each of the K partitions comprises at least one of the m training locations, and K is a natural number greater than 1;
downloading the clustering look-up table from the system server to the communication device;
finding the to-be-positioned location of the communication device approaching at least one current position partition of the K partitions according to start position data corresponding to the to-be-positioned location of the communication device; and
downloading a portion the K groups of the first set and the second set of parameters corresponding to the at least one current position partition, and therefrom establishing the positioning function and generating the positioning result data.

14. (canceled)

15. (canceled)

16. The method according to claim 13, further comprising the step of:
calculating a relationship between a position of the communication device and a physical position of at least one current position partition according to the obtained positioning result data, and therefrom determining whether to download the other portion of the K groups of the first set and the second set of parameters or not so as to perform the positioning operation on the communication device.

17. The method according to claim 16, further comprising the step of:
determining to download the other portion of the K groups of the first set and the second set of parameters when the positioning result data indicates that the position of the communication device approaches a boundary of the at least one current position partition.

18. The method according to claim 17, further comprising the steps of:
finding moving direction data of the communication device according to x sets of the positioning result data obtained in previous x positioning operations, wherein x is a natural number greater than 1; and
finding a next position partition according to the moving direction data, and correspondingly downloading the other portion of the K groups of the first set and the second set of parameters, which corresponds to the next position partition.

19. The method according to claim 17, further comprising the step of
selecting y peripheral position partitions around the at least one current position partition as a next set of possible position partitions, and correspondingly downloading the other portion of the K groups of the first set and the second set of parameters, which corresponds to the next set of possible position partitions, wherein y is a natural number.

20. The method according to claim 17, further comprising the step of:
selecting N peripheral position partitions around the at least one current position partition as a next set of possible position partitions, and correspondingly downloading the other portion of the K groups of the first set and the second set of parameters, which corresponds to the next set of possible position partitions, wherein N is a natural number.
